(19) United States
(12) Patent Application Publication
(10) Pub. No.: US 2014/0268197 A1
(43) Pub. Date: Sep. 18, 2014

(54) IMAGE FORMING APPARATUS AND IMAGE FORMING METHOD

(71) Applicant: Sharp Kabushiki Kaisha, Osaka (JP)

(72) Inventor: Yohsuke KAMETANI, Osaka (JP)

(73) Assignee: Sharp Kabushiki Kaisha, Osaka (JP)

(21) Appl. No.: 14/161,015

(22) Filed: Jan. 22, 2014

(30) Foreign Application Priority Data
Mar. 14, 2013 (JP) 2013-051214

(51) Int. Cl. H04N 1/00; H04N 1/23

(52) U.S. Cl. CPC H04N 1/00633; H04N 1/23
USPC 358/1.12

(57) ABSTRACT

Provided are an image forming apparatus and method in which, even when storage capacity becomes insufficient for a printing instruction of a plurality of copies, the printing instruction of the copies is able to be executed to the last. Included is an output control portion for, when a printing instruction of a plurality of copies is given and a storage capacity becomes insufficient while printing execution data of a predetermined page is being created, detecting available paper discharge trays and changing to output to the paper discharge trays. When the printing instruction of the copies is given and the storage capacity becomes insufficient, printing execution data which has been created is printed to output to the available paper discharge trays and printing execution data which has been printed is deleted to prepare for creating of printing execution data concerning pages which have not been created.

### CROSS-NOTING PARAGRAPH

This non-provisional application claims priority under 35 U.S.C. §119(a) on Patent Application No. 2013-051214 filed in JAPAN on Mar. 14, 2013, the entire contents of which are hereby incorporated herein by reference.

### FIELD OF THE INVENTION

The present invention relates to an image forming apparatus and image forming method, in which printing execution data is created based on received printing data as well as a plurality of copies of printed matters are able to be output from at least one paper discharge tray among a plurality of paper discharge trays.

### BACKGROUND OF THE INVENTION

In an image forming apparatus, printing execution data is created from printing data described with a page description language such as Post Script, and an image based on this printing execution data is printed on a sheet to be output to a paper discharge tray. For example, when printing data is received from a host computer, the page description language is interpreted by an interpreter to generate an intermediate code, the intermediate code is subjected to rendering to generate raster data composed of bitmap data, and halftone processing or the like is performed for the raster data to create printing execution data.

When a plurality of copies (for example, two copies) of the same document are printed, printing execution data which has been created is saved in a storage portion such as a RAM and called at the time of printing the first copy and at the time of printing the second copy for printing on a sheet. This makes it possible to output collated two copies of printed matters in total to a paper discharge tray.

Here, in a case where each printed matter is sorted to a plurality of paper discharge trays to be output, when the number of copies instructed to be printed exceeds the number of the paper discharge trays, it becomes impossible to execute the printing instruction of the plurality of copies to the last. Therefore, for example, Japanese Laid-Open Patent Publication No. 2000-118857 discloses a technology that a paper discharge tray to which output is performed at first is specified again and a plurality of paper discharge trays are used repeatedly.

In the meantime, as Japanese Laid-Open Patent Publication No. 2000-118857, when a plurality of copies of printed matters are always output from a plurality of paper discharge trays, an output destination needs to be set by an image forming apparatus or the like, and a user needs to access each paper discharge tray to take out the printed matters. Thus, it is considered to cause the plurality of copies to be output from one paper discharge tray.

However, there is a problem that, in a case where storage capacity of a storage portion becomes insufficient while printing execution data is being created, printing execution data of subsequent pages are not able to be created.

Specifically, for example, when assuming a case where an instruction is given to print two copies of one with a hundred pages and printing execution data up to the fiftieth page is created and saved, but the storage capacity becomes insufficient for the fifty-first page, the fifty-first and subsequent pages become difficult to be printed.

Here, even if the printing execution data which has been created (up to the fiftieth page) is printed for two copies and output to one paper discharge tray and then deleted from the storage portion to solve insufficiency of the storage capacity so that printing execution data of the continuous fifty-first and subsequent pages is able to be created and printed, when a plurality of copies are output from one paper discharge tray, printed matters up to the fiftieth page of the second copy (or printed matters capable of being corresponding to all pages of the second copy) exist between printed matters up to the fiftieth page of the first copy and printed matters of the fifty-first and subsequent pages of the first copy, so that it is impossible to collect the printing execution data before insufficiency of the storage capacity and the printing execution data after solving insufficiency according to order of pages.

### SUMMARY OF THE INVENTION

The present invention aims to provide an image forming apparatus and image forming method, in which, even when storage capacity becomes insufficient for a printing instruction of a plurality of copies, it is possible to execute the printing instruction of the plurality of copies to the last.

An object of the present invention is to provide an image forming apparatus which creates printing execution data based on received printing data as well as is able to output a plurality of copies of printed matters from at least one paper discharge tray among a plurality of paper discharge trays, comprising: a storage portion for saving the printing execution data which has been created; a storage capacity judging portion for judging insufficiency of storage capacity of the storage portion while printing execution data of a predetermined page is being created; and an output control portion for, when a printing instruction of a plurality of copies is given and the storage capacity of the storage portion becomes insufficient, detecting available paper discharge trays among the plurality of paper discharge trays and changing to output to the available paper discharge trays, wherein when the printing instruction of the plurality of copies is given and the storage capacity of the storage portion becomes insufficient, printing execution data concerning pages that have been created is printed to output to the available paper discharge trays as well as printing execution data concerning pages that have been printed is deleted from the storage portion to prepare for creating of printing execution data concerning pages which have not been created.

Another object of the present invention is to provide the image forming apparatus, wherein in a case where the number of copies instructed to be printed exceeds the number of the available paper discharge trays, when output to the available paper discharge trays is finished, until the number of copies instructed to be printed is reached, the printing data is requested to a transmission source of the printing data.

Another object of the present invention is to provide the image forming apparatus, wherein when changing to output to the available paper discharge trays is performed, output content to the paper discharge trays after the changing is notified to a user.

Another object of the present invention is to provide the image forming apparatus, wherein in output of second and subsequent copies, a paper discharge tray closest to a paper discharge tray which is used for output of a first copy is selected from among the available paper discharge trays.

Another object of the present invention is to provide an image forming method which creates printing execution data based on received printing data as well as is able to output a plurality of copies of printed matters from at least one paper discharge tray among a plurality of paper discharge trays, comprising: a step of saving the printing execution data which has been created in a storage portion; a step of judging insufficiency of storage capacity of the storage portion while printing execution data of a predetermined page is being created; and a step of, when a printing instruction of a plurality of copies is given and the storage capacity of the storage portion becomes insufficient, detecting available paper discharge trays among the plurality of paper discharge trays; and a step of changing to output to the available paper discharge trays, wherein when the printing instruction of the plurality of copies is given and the storage capacity of the storage portion becomes insufficient, printing execution data concerning pages that have been created is printed to output to the available paper discharge trays as well as printing execution data concerning pages that have been printed is deleted from the storage portion to prepare for creating of printing execution data concerning pages which have not been created.

### BRIEF DESCRIPTION OF THE DRAWINGS

FIG. 1 is an external perspective view of an image forming apparatus according to the present invention;

FIG. 2 is a structural view of the image forming apparatus according to the present invention;

FIG. 3 is a flowchart for explaining printing of plurality of copies according to the present invention;

FIG. 4 is a flowchart for explaining changing to a plurality of paper discharge trays of FIG. 3;

FIG. 5 is a flowchart for explaining notification of an output destination of FIG. 3; and

FIG. 6A and FIG. 6B are views showing the notification of the output destination of FIG. 5.

### PREFERRED EMBODIMENTS OF THE INVENTION

Description will be given below for an image forming apparatus of the present invention with reference to drawings. FIG. 1 is an external perspective view of the image forming apparatus according to the present invention. An image forming apparatus 1 has an apparatus main body 10, for example, of an in-body discharge type, and a scanner portion 11 mounted with an automatic document feeder (ADF) 12 is provided above the apparatus main body 10. Note that, a document presser may be used in place of the automatic document feeder 12.

A center paper discharge tray 14 is provided below the scanner portion 11, and this paper discharge tray 14 allows a sheet which has been printed to be easily taken out from a front face or a right-side face of the apparatus main body 10.

Inside the apparatus main body 10, a print engine 13 which will be described in FIG. 2 is arranged below the center paper discharge tray 14. A cassette-type paper feed tray 15 is arranged below the print engine 13, and the paper feed tray 15 is able to be pulled out, for example, to the front face side of the apparatus main body 10. Note that, a manual tray may be arranged in the right-side face of the apparatus main body 10.

A left-side face of the apparatus main body 10 is connected to a post-processing device 16. The post-processing device 16 has, for example, an upper paper discharge tray 17 and a lower paper discharge tray 18, and when a user desires processing of paper folding, stapling, punching for filing or the like of a sheet after printing, each processing is applied to a sheet fed from the apparatus main body 10 to output to the upper paper discharge tray 17 or the lower paper discharge tray 18.

Moreover, as will be described below, it is configured so that, even when printing of a plurality of copies is instructed, a sheet which has been printed from the apparatus main body 10 is able to be output to the upper paper discharge tray 17 or the lower paper discharge tray 18 of the post-processing device 16. Thus, the center paper discharge tray 14, the upper paper discharge tray 17 and the lower paper discharge tray 18 correspond to paper discharge trays of the present invention.

FIG. 2 is a structural view of the image forming apparatus according to the present invention. The image forming apparatus 1 has, in addition to the above-described components, a display 19, an operation panel 20, a CPU (Central Processing Unit) 21, a RAM (Random Access Memory) 22, a ROM (Read Only Memory) 23, an HDD (Hard Disk Drive) 24, a network controller 26, a printer controller 27, a scanner controller 28, an I/O controller 29 and the like, and these various units are connected via an internal bus 25 so as to be able to communicate with each other.

The CPU 21 functions as a control portion for controlling the various units, and is able to communicate with a host computer 100 via the network controller 26.

The CPU 21 loads, for example, various programs and data stored in the ROM 23 to the RAM 22 to execute the loaded programs in the RAM 22. Thereby, while processing data, the whole action of the image forming apparatus 1 is controlled based on instruction content from the user and the like.

The scanner portion 11 is connected to the CPU 21 via the scanner controller 28, and the display 19 and the operation panel 20 are connected to the CPU 21 via the I/O controller 29.

The operation panel 20 is composed of, for example, a touch panel of a transparent resistance film type, and is formed being superimposed on the display 19 composed of liquid crystal, for example. On the display 19, a GUI (Graphical User Interface) for operating the image forming apparatus 1 is displayed. Note that, an operation key composed of a hard key using contact may be provided in the vicinity of the operation panel 20.

The print engine 13 has an image forming portion 13a, and is connected to the CPU 21 via the printer controller 27. Note that, the printer controller 27 corresponds to an output control portion of the present invention.

In the present example, when an instruction to print a plurality of copies of printing data received from the host computer 100 is input, the image forming portion 13a performs various processing such as interpreting, rendering, halftone processing and the like for the printing data to create printing execution data. The RAM 22 and the HDD 24 are able to save the created printing execution data and the like, for example, by compressing. Note that, the RAM 22 and the HDD 24 correspond to a storage portion of the present invention.

The print engine 13 is able to execute printing by performing paper feed, image formation, transferring, fixing, paper discharge and the like, and the printing execution data saved in the RAM 22 and the like is called to form an electrostatic latent image, for example, by extending and this electrostatic latent image is developed with toner for visualizing. This visualized image is able to be transferred and fixed onto a sheet and output to the center paper discharge tray 14, the upper paper discharge tray 17 or the lower paper discharge tray 18.

In the meantime, as a characteristic structure of the image forming apparatus 1, the CPU 21 functions as a storage capacity judging portion 21a. Moreover, the printer controller 27 functions as an acquiring portion 27a, a judging portion 27b, a selecting portion 27c and a notifying portion 27d.

In addition, when an instruction to print a plurality of copies of printing data is input and storage capacity of the RAM 22 and the like becomes insufficient, the printer controller 27 detects paper discharge trays available in the image forming apparatus 1 and changes output from one site to output from a plurality of paper discharge trays for printing.

FIG. 3 is a flowchart for explaining printing of a plurality of copies according to the present invention, and FIG. 4 is a flowchart for explaining changing to a plurality of paper discharge trays of FIG. 3.

For example, when printing data is received from the host computer 100 and a printing instruction of a plurality of copies (for example, two copies of one with fifty pages) has been given as to this printing data (step S101 of FIG. 3), the image forming portion 13a creates printing execution data of the first page based on the printing data (step S102).

The storage capacity judging portion 21a judges whether or not the created printing execution data of the first page is able to be saved in the RAM 22 and the like, and when judging that the storage capacity is not insufficient (NO at step S103), the printer controller 27 saves the created printing execution data of the first page in the RAM 22 and the like (step S104).

Next, the procedure returns to step S102 from step S105 to create printing execution data of the second page, and printing execution data of the second page is created based on the printing data (step S102). When the storage capacity is not insufficient (NO at step S103), the printing execution data of the second page is also saved in the RAM 22 and the like (step S104). Subsequently, unless the storage capacity is insufficient, creating and saving of printing execution data up to the fiftieth page are repeated (step S102 to step S105).

The printer controller 27 judges creating of printing execution data of all pages (YES at step S105), and, like in this example, when printing execution data is created and saved without insufficiency of the storage capacity, this printing execution data is called from the RAM 22 and the like and pages from the first page to the fiftieth page are printed in turn to output printed matters of the first copy to the center paper discharge tray 14. Subsequently, the printing execution data is called from the RAM 22 and the like and pages from the first page to the fiftieth page are printed in turn to output printed matters of the second copy to the center paper discharge tray 14 (YES at step S106), and the procedure moves to the next step S107. On the center paper discharge tray 14, the printed matters of the first copy and the printed matters of the second copy are able to be arranged, for example, in a state of being shifted slightly in a sheet width direction.

FIG. 5 is a flowchart for explaining notification of an output destination of FIG. 3. At step S301, whether or not an output destination is changed to a plurality of paper discharge trays is judged, and, like in this example, when the output destination is not changed with the center paper discharge tray 14 remained (NO at step S301), the notifying portion 27d notifies the host computer 100 and the display 19 that output is performed to the center paper discharge tray 14 as the output destination which is set at first (step S302). Note that, the user may be informed by printing a notice page on which output destination information is described.

On the other hand, assumed is a case where, for example, a printing instruction of two copies of one with a hundred pages has been given as to printing data received by the image forming apparatus 1 (step S101 of FIG. 3).

The image forming portion 13a creates printing execution data from the first page in turn based on the printing data, and unless the storage capacity becomes insufficient, repeats creating and saving of printing execution data (step S102 to step S105).

Here, for example, in a case where printing execution data up to the fiftieth page is created and saved in the RAM 22 and the like, but when trying to create and save printing execution data of the fifty-first page, the storage capacity judging portion 21a judges the storage capacity as being insufficient (YES at step S103), the procedure moves to step S108, and the printer controller 27 changes the output destination to a plurality of paper discharge trays.

Specifically, as shown in FIG. 4, first, the acquiring portion 27a detects paper discharge trays available in the image forming apparatus 1 (for example, two sites of the center paper discharge tray 14 and the upper paper discharge tray 17) to acquire the number of the paper discharge trays (step S201).

Next, the judging portion 27b compares the number of copies instructed to be printed and the acquired number of the paper discharge trays to judge whether or not the number of the paper discharge trays exceeds the specified number of copies. In the case of this example, since the specified number of copies (for example, two copies) and the acquired number of the paper discharge trays (for example, two sites) are the same and the paper discharge trays are sufficient (YES at step S202), the selecting portion 27c changes the output destination from one site of the center paper discharge tray 14 to two sites of the center paper discharge tray 14 and the upper paper discharge tray 17, and the procedure moves to step S205.

At this step S205, printing execution data concerning the pages that have been created (up to the fiftieth page) is called from the RAM 22 and the like and pages from the first page to the fiftieth page are printed in turn, to output printed matters up to the fiftieth page of the first copy to the center paper discharge tray 14 and printed matters up to the fiftieth page of the second copy to the upper paper discharge tray 17 (step S205). Thereafter, the printing execution data concerning the pages that have been printed (up to the fiftieth page) is deleted from the RAM 22 and the like (step S206) and insufficiency of the storage capacity is solved to prepare for creating of printing execution data concerning pages that have not been created.

Next, since pages up to the fiftieth page are output in turn, but creating and output of printing execution data of the fifty-first and subsequent pages are not performed (NO at step S105 of FIG. 3), the procedure returns to step S102 to create printing execution data of the fifty-first and subsequent pages. Based on the printing data of the fifty-first and subsequent pages that has been received, the image forming portion 13a creates printing execution data from the fifty-first page that has been interrupted because of insufficiency of the storage capacity in turn, and unless the storage capacity becomes insufficient, creating and saving of printing execution data up to the hundredth page are repeated (step S102 to step S105).

The printer controller 27 judges creating of printing execution data of all pages (YES at step S105) and, like in this example, when the fifty-first and subsequent pages of the first and second copies have not been output yet, the procedure moves to step S205 of FIG. 4, and this printing execution data that has not been created is called from the RAM 22 and the like and pages from the fifty-first page to the hundredth page are printed in turn, to output printed matters from the fifty-first page to the hundredth page of the first copy to the center paper discharge tray 14 and printed matters from the fifty-first page to the hundredth page of the second copy to the upper paper discharge tray 17 (step S205).

Thereby, both the first and second copies become the printed matters in which the fiftieth page is followed up to the fifty-first page and pages from the first page to the hundredth page are arranged in turn. Thereafter, the printing execution data concerning the pages that have been printed (from the fifty-first page to the hundredth page) is deleted from the RAM 22 and the like (step S206) to solve insufficiency of the storage capacity. When all copies are printed (YES at step S106 of FIG. 3), the procedure moves to step S107.

In this example, the selecting portion 27c changes the output destination to two sites of the center paper discharge tray 14 and the upper paper discharge tray 17 (YES at step S301 of FIG. 5). The notifying portion 27d notifies the host computer 100 and the display 19 that the output is performed to the center paper discharge tray 14 and the upper paper discharge tray 17 as the output destination after the changing (step S303).

FIG. 6A and FIG. 6B are views showing the notification of the output destination of FIG. 5. As shown in FIG. 6A, the notifying portion 27d displays that the output destination is changed to a plurality of paper discharge trays as well as creates message that, for example, one copy is output to the center paper discharge tray 14 and one copy is output to the upper paper discharge tray 17 to notify the host computer 100 and the like. Therefore, it is possible to prevent forgetting to take out printed matters to improve convenience.

In this manner, when a printing instruction of a plurality of copies is given, basically, output is performed from one paper discharge tray to make setting and access easy. However, when the storage capacity of the RAM 22 and the like becomes insufficient, available paper discharge trays are detected to change output from one paper discharge tray to output from a plurality of paper discharge trays, and printing execution data of the pages that have been created is output to the plurality of paper discharge trays. In addition, when it is able to create printing execution data of continuous pages by solving insufficiency of the storage capacity, output is performed from the paper discharge trays after the changing in the same manner. Therefore, it is possible to collect the printing execution data before insufficiency of the storage capacity (up to the fiftieth page) and the printing execution data after solving insufficiency (after the fifty-first page) according to order of pages.

On the other hand, assumed is a case where, for example, a printing instruction of four copies of one with a hundred pages has been given as to printing data received by the image forming apparatus 1 (step S101 of FIG. 3).

The image forming portion 13a creates printing execution data from the first page in turn based on the printing data, and unless the storage capacity becomes insufficient, repeats creating and saving of printing execution data (step S102 to step S105).

For example, when trying to create and save printing execution data of the fifty-first page, if the storage capacity judging portion 21a judges the storage capacity as being insufficient (YES at step S103), the printer controller 27 changes the output destination to a plurality of paper discharge trays (step S108).

The acquiring portion 27a detects paper discharge trays available in the image forming apparatus 1 (for example, two sites of the upper paper discharge tray 17 and the lower paper discharge tray 18) to acquire the number of the paper discharge trays (step S201 of FIG. 4).

The judging portion 27b compares the number of copies instructed to be printed and the acquired number of the paper discharge trays, and when the specified number of copies (for example, four copies) exceeds the number of the paper discharge trays (for example, two sites), the paper discharge trays are insufficient (NO at step S202), so that the procedure moves to step S203 to select the output destination.

Here, when the output destination of the first copy is specified, for example, to the upper paper discharge tray 17 by the user (or as standard setting in the image forming apparatus) (step S203), the selecting portion 27c automatically selects the paper discharge tray adjacent to this output destination of the first copy as the output destination of the second and subsequent copies (step S204). In this manner, even when output to one paper discharge tray is changed to output to a plurality of paper discharge trays, these paper discharge trays are in proximity to each other, thus making it possible to prevent forgetting to take out printed matters to improve convenience.

In addition, in the case of an example in which two sites of the upper paper discharge tray 17 and the lower paper discharge tray 18 are available and four copies are output, the output destination of the second copy and the fourth copy is set to the lower paper discharge tray 18 and the output destination of the third copy is set to the upper paper discharge tray 17 that is the same as the output destination of the first copy.

Note that, since the object of the present invention is able to be attained by outputting printing execution data printed at the same time to separate paper discharge trays, the output destination of the first copy and the fourth copy may be set to the upper paper discharge tray 17 and the output destination of the second copy and the third copy may be set to the lower paper discharge tray 18.

Subsequently, printing execution data concerning the pages that have been created (up to the fiftieth page) is called from the RAM 22 and the like and pages from the first page to the fiftieth page are printed in turn, to output printed matters up to the fiftieth page of the first copy to the upper paper discharge tray 17 and printed matters up to the fiftieth page of the second copy to the lower paper discharge tray 18 (step S205). Thereafter, the printing execution data concerning the pages that have been printed (up to the fiftieth page) is deleted from the RAM 22 and the like (step S206).

Subsequently, the procedure returns to step S102 from step S105 of FIG. 3 to create printing execution data of the fifty-first and subsequent pages. Based on the printing data of the fifty-first and subsequent pages that has been received, the image forming portion 13a creates printing execution data from the fifty-first page that has been interrupted because of insufficiency of the storage capacity in turn, and unless the storage capacity becomes insufficient, creating and saving of printing execution data up to the hundredth page are repeated (step S102 to step S105).

When this printing execution data up to the hundredth page is created (YES at step S105), the fifty-first and subsequent pages of the first and second copies have not been output yet. Thus, printing execution data that has not been created is called from the RAM 22 and the like, and pages from the fifty-first page to the hundredth page are printed in turn, to output printed matters from the fifty-first page to the hundredth page of the first copy to the upper paper discharge tray 17 and printed matters from the fifty-first page to the hundredth page of the second copy to the lower paper discharge tray 18 (step S205 of FIG. 4).

Thereby, both the first and second copies become the printed matters in which the fiftieth page is followed by the fifty-first page and pages from the first page to the hundredth page are arranged in turn. Thereafter, the printing execution data concerning the pages that have been printed (from the fifty-first page to the hundredth page) is deleted from the RAM 22 and the like (step S206).

Subsequently, the procedure moves to step S109 from step S106 of FIG. 3 to print the third and fourth copies, and the image forming apparatus 1 notifies the host computer 100 of the printed number of copies (two copies). This is because, as described above, the printed printing execution data has been already deleted from the RAM 22 and the like, and the printing data used for creating the printing execution data in this time (the first and second copies in the case of the above-described example) is not saved, for example, in the RAM 22 and the like, and therefore is not able to be used for creating printing execution data next time (the third and fourth copies in the case of the above-described example).

The host computer 100 reduces the number of copies which has been instructed to be printed before (four copies) by the printed number of copies notified in this time (two copies), and transmits a printing instruction of two copies of one with a hundred pages to the image forming apparatus 1 again (step S101 of FIG. 3). The image forming portion 13a repeats creating and saving of printing execution data in turn from the first page (step S102 to S105).

For example, when trying to create and save printing execution data of the fifty-first page, if the storage capacity judging portion 21a judges the storage capacity as being insufficient (YES at step S103), the printer controller 27 changes the output destination to a plurality of paper discharge trays (step S108).

The acquiring portion 27a detects paper discharge trays available in the image forming apparatus 1 (for example, two sites of the upper paper discharge tray 17 and the lower paper discharge tray 18) to acquire the number of the paper discharge trays (step S201 of FIG. 4).

When the judging portion 27b compares the number of copies instructed to be printed and the acquired number of the paper discharge trays, since the specified number of copies (for example, two copies) is the same as the acquired number of the paper discharge trays (for example, two sites), it is found that the paper discharge trays are sufficient (YES at step S202). As having set before, the selecting portion 27c sets the output destination of the third copy to the upper paper discharge tray 17 that is the same as the output destination of the first copy, and the output destination of the fourth copy to the lower paper discharge tray 18 that is the same as the output destination of the second copy.

Subsequently, the printing execution data concerning the pages that have been created (up to the fiftieth page) is called from the RAM 22 and the like and pages from the first page to the fiftieth page are printed in turn, to output printed matters up to the fiftieth page of the third copy to the upper paper discharge tray 17 and printed matters up to the fiftieth page of the fourth copy to the lower paper discharge tray 18 (step S205). Thereafter, the printing execution data concerning the pages that have been printed (up to the fiftieth page) is deleted from the RAM 22 and the like (step S206). Note that, the printed matters of the first copy and the printed matters of the third copy on the upper paper discharge tray 17 and the printed matters of the second copy and the printed matters of the fourth copy on the lower paper discharge tray 18 are able to be arranged, for example, in a state of being shifted slightly in a sheet width direction.

Next, the procedure returns to step S102 from step S105 of FIG. 3 to create printing execution data of the fifty-first and subsequent pages. Based on the printing data of the fifty-first and subsequent pages that has been received again, the image forming portion 13a repeats creating and saving of printing execution data up to the hundredth page in turn from printing execution data of the fifty-first page that has been interrupted because of insufficiency of the storage capacity (step S102 to step S105).

When this printing execution data up to the hundredth page is created, printing execution data of the fifty-first and subsequent pages of the third and fourth copies that have not been created is called from the RAM 22 and the like and pages from the fifty-first page to the hundredth page are printed in turn, to output printed matters from the fifty-first page to the hundredth page of the third copy to the upper paper discharge tray 17 and the printed matters from the fifty-first page to the hundredth page of the fourth copy to the lower paper discharge tray 18 (step S205 of FIG. 4).

Thereby, both the third and fourth copies become the printed matters in which the fiftieth page is followed up to the fifty-first page and pages from the first page to the hundredth page are arranged in turn. Thereafter, the printing execution data concerning the pages that have been printed (from the fifty-first page to the hundredth page) is deleted from the RAM 22 and the like (step S206).

In this manner, even after printing is performed only by the number of the paper discharge trays available in the image forming apparatus 1, printing data is requested to a transmission source thereof, so that it is possible to execute a printing instruction of a plurality of copies (four copies of one with one to hundred pages in the case of the above-described example) to the last (YES at step S107 of FIG. 3).

In this example, the output destination is changed to two sites of the upper paper discharge tray 17 and the lower paper discharge tray 18 (YES at step S301 of FIG. 5). The notifying portion 27d notifies the host computer 100 and the display 19 that the output is performed to the upper paper discharge tray and the lower paper discharge tray 18 as the output destination after the changing (step S303).

Specifically, as shown in FIG. 6B, the notifying portion 27d displays that the output destination is changed to a plurality of paper discharge trays as well as creates message that, for example, two copies are output to the upper paper discharge tray 17 and two copies are output to the lower paper discharge tray 18 to notify the host computer 100 and the like.

In the meantime, in a case where the above-described printing instruction of four copies of one with a hundred pages has been given, after pages from the fifty-first page to the hundredth page of the first and second copies are printed and output to the paper discharge trays, this printing execution data which has been printed may be used to print also pages from the fifty-first page to the hundredth page of the third and fourth copies and then deleted.

Specifically, for the pages from the fifty-first page to the hundredth page of the third and fourth copies, for example, by performing output to the paper discharge trays in turn from the hundredth page with sheets of the first and second copies reversed, the printed matters of the first and second copies are able to be distinguished. Thereby, as to the third and fourth copies, it becomes unnecessary to request printing data to a transmission source in order to create pages from the fifty-first page to the hundredth page, and it becomes unnecessary to create printing execution data based on this printing data, thus reducing loads on data communication and making it possible to prevent lowering of printing performance.

Moreover, also when a recording medium having a program code of software for realizing functions of the above-described component example recorded therein is supplied to the image forming apparatus and the program code is executed by a micro processor (or DSP: Digital Signal Processor), the object of the present invention is able to be attained. In this case, the program code itself of the software is to realize the functions of the above-described component example, and the program code itself, an image forming method and the like constitute the present invention.

Hereinabove, the embodiment has been described, and the present invention is an image forming apparatus which creates printing execution data based on received printing data as well as is able to output a plurality of copies of printed matters from at least one paper discharge tray among a plurality of paper discharge trays, that may include a storage portion for saving the printing execution data which has been created, a storage capacity judging portion for judging insufficiency of storage capacity of the storage portion while printing execution data of a predetermined page is being created, and an output control portion for, when a printing instruction of a plurality of copies is given and the storage capacity of the storage portion becomes insufficient, detecting available paper discharge trays among the plurality of paper discharge trays and changing to output to the available paper discharge trays, and may be characterized in that when the printing instruction of the plurality of copies is given and the storage capacity of the storage portion becomes insufficient, printing execution data concerning pages that have been created is printed to output to the available paper discharge trays as well as printing execution data concerning pages that have been printed is deleted from the storage portion to prepare for creating of printing execution data concerning pages which have not been created.

In this manner, when a printing instruction of a plurality of copies is given, basically, output is performed from one paper discharge tray to make setting of the image forming apparatus and the like and access by the user easy, but when the storage capacity of the storage portion becomes insufficient, available paper discharge trays are detected to change output from one site to output from the plurality of paper discharge trays, and printing execution data of pages that have been created is output to the plurality of paper discharge trays. In addition, insufficiency of the storage capacity is solved to prepare for creating of printing execution data of subsequent pages. Therefore, it is possible to collect the printing execution data before insufficiency of the storage capacity and the printing execution data after solving insufficiency according to order of pages, thus making it possible to execute the printing instruction of the plurality of copies to the last.

Moreover, in a case where the number of copies instructed to be printed exceeds the number of the available paper discharge trays, when output to the available paper discharge trays is finished, until the number of copies instructed to be printed is reached, the printing data may be requested to a transmission source of the printing data. In this case, even after output is performed only by the number of the paper discharge trays available in the image forming apparatus, the printing data is requested to the transmission source thereof, thus making it possible to execute the printing instruction of the plurality of copies to the last.

Moreover, when changing to output to the available paper discharge trays is performed, output content to the paper discharge trays after the changing may be notified to a user. In this case, even when output from one paper discharge tray is changed to output from the plurality of paper discharge trays, the paper discharge trays after the changing is notified to the user, thus making it possible to prevent forgetting to take out printed matters to improve convenience.

Moreover, in output of second and subsequent copies, a paper discharge tray closest to a paper discharge tray which is used for output of a first copy may be selected from among the available paper discharge trays. In this case, even when output from one paper discharge tray is changed to output from the plurality of paper discharge trays, these paper discharge trays are in proximity to each other, thus making it possible to prevent forgetting to take out printed matters to improve convenience.

Moreover, an image forming method which creates printing execution data based on received printing data as well as is able to output a plurality of copies of printed matters from at least one paper discharge tray among a plurality of paper discharge trays, is able to include a step of saving the printing execution data which has been created in a storage portion, a step of judging insufficiency of storage capacity of the storage portion while printing execution data of a predetermined page, is being created, and a step of, when a printing instruction of a plurality of copies is given and the storage capacity of the storage portion becomes insufficient, detecting available paper discharge trays among the plurality of paper discharge trays and a step of changing to output to the available paper discharge trays, and is able to be characterized in that, when the printing instruction of the plurality of copies is given and the storage capacity of the storage portion becomes insufficient, printing execution data concerning pages that have been created is printed to output to the available paper discharge trays as well as printing execution data concerning pages that have been printed is deleted from the storage portion to prepare for creating of printing execution data concerning pages which have not been created.

In the apparatus which carries out this image forming method, it is possible to collect the printing execution data before insufficiency of the storage capacity and the printing execution data after solving insufficiency according to order of pages, thus making it possible to execute the printing instruction of the plurality of copies to the last.

Hereinabove, according to the present invention, when a printing instruction of a plurality of copies is given, basically, output is performed from one paper discharge tray to make setting of the image forming apparatus and the like and access by the user easy, but when the storage capacity of the storage portion becomes insufficient, available paper discharge trays are detected to change output from one site to output from the plurality of paper discharge trays, and printing execution data of pages that have been created is output to the plurality of paper discharge trays. In addition, insufficiency of the storage capacity is solved to prepare for creating of printing execution data of subsequent pages. Therefore, it is possible to collect the printing execution data before insufficiency of the storage capacity and the printing execution data after solving insufficiency according to order of pages, thus making it possible to execute the printing instruction of the plurality of copies to the last.

1. An image forming apparatus which creates printing execution data based on received printing data as well as is able to output a plurality of copies of printed matters from at least one paper discharge tray among a plurality of paper discharge trays, comprising:
a storage portion for saving the printing execution data which has been created; a storage capacity judging portion for judging insufficiency of storage capacity of the storage portion while printing execution data of a predetermined page is being created; and an output control portion for, when a printing instruction of a plurality of copies is given and the storage capacity of the storage portion becomes insufficient, detecting available paper discharge trays among the plurality of paper discharge trays and changing to output to the available paper discharge trays, wherein
when the printing instruction of the plurality of copies is given and the storage capacity of the storage portion becomes insufficient, printing execution data concerning pages that have been created is printed to output to the available paper discharge trays as well as printing execution data concerning pages that have been printed is deleted from the storage portion to prepare for creating of printing execution data concerning pages which have not been created.

2. The image forming apparatus as defined in claim 1, wherein
in a case where the number of copies instructed to be printed exceeds the number of the available paper discharge trays, when output to the available paper discharge trays is finished, until the number of copies instructed to be printed is reached, the printing data is requested to a transmission source of the printing data.

3. The image forming apparatus as defined in claim 1, wherein
when changing to output to the available paper discharge trays is performed, output content to the paper discharge trays after the changing is notified to a user.

4. The image forming apparatus as defined in claim 1, wherein
in output of second and subsequent copies, a paper discharge tray closest to a paper discharge tray which is used for output of a first copy is selected from among the available paper discharge trays.

5. An image forming method which creates printing execution data based on received printing data as well as is able to output a plurality of copies of printed matters from at least one paper discharge tray among a plurality of paper discharge trays, comprising:
a step of saving the printing execution data which has been created in a storage portion; a step of judging insufficiency of storage capacity of the storage portion while printing execution data of a predetermined page is being created; and a step of, when a printing instruction of a plurality of copies is given and the storage capacity of the storage portion becomes insufficient, detecting available paper discharge trays among the plurality of paper discharge trays; and a step of changing to output to the available paper discharge trays, wherein
when the printing instruction of the plurality of copies is given and the storage capacity of the storage portion becomes insufficient, printing execution data concerning pages that have been created is printed to output to the available paper discharge trays as well as printing execution data concerning pages that have been printed is deleted from the storage portion to prepare for creating of printing execution data concerning pages which have not been created.
